(19) United States
(12) Patent Application Publication
(10) Pub. No.: US 2025/0172939 A1
(43) Pub. Date: May 29, 2025

(54) USER-GUIDED SEMI-AUTOMATIC NAVIGATION OF A MOBILE MEDICAL DEVICE

(71) Applicant: Siemens Healthineers AG, Forchheim (DE)

(72) Inventors: Andreas DEINLEIN, Bayreuth (DE); Thorsten GECKS, Weidenberg (DE); Marco MASANNEK, Nuernberg (DE)

(73) Assignee: Siemens Healthineers AG, Forchheim (DE)

(21) Appl. No.: 18/953,285

(22) Filed: Nov. 20, 2024

(30) Foreign Application Priority Data
Nov. 23, 2023 (DE) 10 2023 211 690.1

(51) Int. Cl. G05D 1/228; A61G 12/00; B62B 5/00; G05D 1/622; G05D 107/60

(52) U.S. Cl. CPC G05D 1/2287; A61G 12/001; B62B 5/0073; G05D 1/622; G05D 2107/65

(57) ABSTRACT

A mobile medical device is driven by a chassis. The movement is brought about, or at least supported by, at least one drive. A direction influencing device varies the direction of movement. Both the drive and the direction influencing device may be activated by a control device. End stations and paths leading to the end stations, as well as a current position of the device, are known to the control device. The control device accepts a drive request from an operator and establishes an at least approximate desired direction of the movement. The control device activates the drive while accepting the drive request and activates the direction influencing device to drive the device on one of the paths while accepting the drive request and while the current position of the device is approximately on the path. Furthermore, the control device continuously updates the position of the device during movement.

### CROSS-REFERENCE TO RELATED APPLICATION(S)

The present application claims priority under 35U.S.C. § 119 to German Patent Application No. 10 2023 211 690.1, filed Nov. 23, 2023, the entire contents of which is incorporated herein by reference.

### BACKGROUND

In the prior art, mobile medical devices are moved manually by operators between various diagnosis and treatment stations. When this involves large devices then the devices are often so large and heavy that motorized support is required to move them. Despite this and in some cases even for this reason, the handling is still not easy for the operator. This is especially true when operators are still relatively inexperienced. Specifically, with obstacles in hospital corridors or constrictions such as doors for example, orderly navigation presents the operator with a major challenge. The same is also true when a corridor has a corner, for example.

Mobile devices that navigate autonomously are used in the logistics environment, for example, in factories, industrial warehouses and logistics centers. These devices move fully automatically along correspondingly programmed paths.

In the medical environment, such autonomous, automatic navigation of mobile medical devices can only be implemented with difficulty. Firstly, the environment is very constricted. Furthermore, it is often also frequented irregularly by patients and other people. Patients could feel frightened by such autonomously driving systems. Furthermore, the technical and normative outlay involved in a functionally safe operation of a fully autonomously driven mobile medical device (in particular in the sense of ISO 14791) would be associated with unacceptably high costs and restrictions.

### SUMMARY

One or more embodiments of the present invention are based on a method of operation for a mobile medical device, with a chassis, by which the device is able to be driven on a floor within a building, with at least one drive, by which a movement of the device can be brought about or at least supported, and with a control facility (also referred to herein as a control device), by which the drive can be activated,
wherein the control facility accepts a drive request from an operator,
wherein the control facility, by evaluating the drive request, establishes an at least approximate desired direction of the movement,
wherein the control facility only activates the drive for as long as it is receiving the drive request.

One or more embodiments of the present invention are furthermore based on a non-transitory computer readable medium storing a control program for a control facility of a mobile medical device that has a chassis, by which the device is able to be driven on a floor within a building, and with at least one drive, by which a movement of the device can be brought about or at least supported, wherein the control program comprises machine code that is able to be processed by the control facility, wherein the processing of the machine code by the control facility causes the control facility to carry out such a method of operation.

One or more embodiments of the present invention are furthermore based on a control facility of a mobile medical device, having a chassis, by which the device is able to be driven on a floor within a building, and at least one drive, by which a movement of the device can be brought about or at least supported, wherein the control facility is programmed with such a control program, so that the control facility carries out such a method of operation when it is in operation.

One or more embodiments of the present invention are furthermore based on a mobile medical device,
wherein the device has a chassis, by which the device is able to be driven on a floor within a building,
wherein the device has at least one drive, by which a movement of the device can be brought about or at least supported,
wherein the device has a control facility, by which it can be activated,
wherein the control facility is embodied as this type of control facility.

One or more embodiments of the present invention provide a method of operation of a mobile medical device, the mobile medical device including a chassis by which the mobile medical device is driven on a floor within a building, at least one drive configured to move, or support movement of, the mobile medical device, a direction influencing device configured to vary a direction of travel of the mobile medical device, and a control device configured to activate the at least one drive and the direction influencing device, wherein a number of end stations and a number of paths leading to the end stations are known to the control device, and wherein a current position of the mobile medical device is known to the control device. The method comprises: accepting, by the control device, a drive request from an operator; establishing, by the control device, at least an approximate desired direction of movement by evaluating the drive request; activating, by the control device, the at least one drive only while the control device is accepting the drive request; activating, by the control device, the direction influencing device to drive the mobile medical device on a path among the paths while the control device is accepting the drive request and while the current position of the mobile medical device is located at least approximately on the path; and continuously updating, by the control device, the current position of the mobile medical device during movement of the mobile medical device.

Such a method of operation is realized for example by the mobile CT head scanner. A patient couch, as is used for example in a magnetic resonance device, can also realize such a method of operation. The further above-mentioned subject matter is also realized by the said mobile CT head scanner and the said patient couch.

An object of one or more embodiments of the present invention involves creating options by which the operating convenience and above all the reliability when driving the mobile medical device can be enhanced, without having to accept the disadvantages of a system that drives fully autonomously.

At least the object is achieved by a method of operation with the features as claimed.

In accordance with embodiments of the present invention, it is first necessary for the mobile medical device additionally to have a direction influencing facility (also referred to as a direction influencing device), by which the direction of travel of the movement can be varied, and the direction influencing facility can likewise be activated by the control facility. Furthermore, a method of operation of the type mentioned at the outset is embodied so that,
a number of end stations and paths leading to the end stations are known to the control facility,
a current position of the device is known to the control facility,
the control facility, when it accepts the drive request and the current position of the device is located at least approximately on one of the paths, activates the direction influencing facility in addition to the drive, so that the device is driven on the path concerned, and
the control facility continuously updates the current position of the device during the movement.

Thus, on the one hand the responsibility of the operator is retained in any event. This is because the control facility only activates the drive when the control facility accepts the drive request (from the operator). Without the drive request the mobile medical device is not driven (at least not by the control facility). Despite this however, the path on which the device is to be driven as a result of the drive request can be known to the control facility and thus kept to by the control facility. The operator is therefore relieved of the load of precise control (navigation) of the device and in practice only has to intervene in cases in which a simple movement along the path is not wanted (for example because there is a person in the way).

The medical device can for example be a diagnosis or therapy device. It can however also involve a patient couch or a hospital bed or the like.

The precise embodiment of the drive and the direction influencing facility can be as required. In the simplest case the drive acts on an axle with one or two wheels and the direction influencing facility is embodied as conventional steering. Other embodiments are also possible however, for example as what is known as Mecanum kinematics. A number of wheels can also be steerable and driven individually, so that, depending on the position and drive of the wheels—for example—moving in a straight line, moving around a corner and also turning around on the spot is possible.

The drive request can be specified in almost any given manner. The simplest involves using a drive button on a handle of the device. Likewise possible is a power grip, i.e. a grip that can detect the force exerted by the operator on the grip. A forward force—starting from the orientation at that moment—specifies the direction of travel as “forwards”, backward force specifies the direction of travel as “backwards”. What is decisive however is that the drive request is not only specified once but can also be retained. The drive is thus activated by the control facility only for as long as the drive request is present, and the drive request is specified, from the point of view of its functionality, as the actuation of a button.

The specification of the drive request in some cases leads only to the specification of an approximate desired direction, since in a similar way as with a motor vehicle, although the drive request defines that the mobile medical device is to be driven forwards (possibly forwards or backwards, depending on the drive request), the precise direction of travel (and also a change to it) by steering or control is only determined during the movement by the operator.

As a rule, the number of end stations is greater than 1. In this case the paths lead as a rule from end station to end station. The totality of end stations and associated paths will also be referred to as a map of the building in some cases below.

The manner in which the current position of the device is known to the control facility can likewise be as required. For example 2, the device can be positioned from time to time (for example once a day or at the beginning of a shift in each case) at a defined position in a defined orientation, wherein this position and this orientation are known to the control facility, so that this position and this orientation can be used as reference values. In the following, a continuation of the orientation by the evaluation of the signals from acceleration sensors and a continuation of the position by the rolling movement of at least one wheel of the chassis (driven or not) can be undertaken in conjunction with the respective orientation. Other possibilities are also provided. For example, cameras which record the mobile medical device permanently or at least from time to time can be installed in the building, so that with the aid of these recordings, the position and the orientation of the mobile medical device are able to be established. The recordings themselves or the position and the orientation can then be transferred to the control facility.

In some cases, the device is driven exclusively on the paths to the end stations. In this case the current position of the device is located at least approximately on one of the paths. In other cases, the device can also be located at positions that do not lie on one of the paths. In this case, the control facility, when a drive request is specified to it, activates the drive so that that the movement as such is brought about or at least supported. The direction influencing facility on the other hand is not activated by the control facility in this case. The direction influencing facility can however be enabled by the control facility such that it is made possible for the operator to steer and turn the medical device. The (active) activation of the direction influencing facility is however (at least as a rule) accepted, as soon as the current position of the device reaches one of the paths.

When the current position of the device is located at least approximately on one of the paths, the direction influencing facility is generally activated by the control facility so that the device remains on the appropriate path. This is true regardless of whether the corresponding path runs in a straight line or has curves. Exceptions to remaining on the corresponding path only apply for corresponding active interventions of the operator.

The formulation “located at least approximately on one of the paths” has been chosen because then for example, when the device is driven parallel to one of the paths at a slight distance from this path for example, there can be a corrective intervention in order to influence the movement so that the device is gradually brought exactly onto the corresponding path.

Preferably the control facility evaluates an effect on a first power grip of the device in a horizontal preferred direction with a force above a first minimum force as a drive request in the horizontal preferred direction. This course of action is especially intuitive for the operator. This is because this is exactly how the operator would proceed if the drive were not present.

A power grip is an element of the device that on the one hand is inherently mechanically stable and is mechanically connected with sufficient stability to the remaining part of the device and on the other hand can recognize a force effect at least in the horizontal preferred direction. The recognition of the force effect can for example be quantitively detected by load cells. It is also possible for the first power grip to have spring-loaded buttons, the spring force of which defines the—small or also larger—minimum force. Depending on the embodiment of the power grip it may be possible only to recognize a force effect in the preferred direction or additionally also opposite to the preferred direction. In the last-mentioned case the control facility can decide between a drive request forwards and a drive request backwards.

Naturally changes in direction initiated by the operator are also possible. For example, the medical device can have a steering device similar to that of a bicycle or motorcycle or a steering wheel similar to that of an automobile. There are also other options for specifying a change of direction. Preferably however the control facility evaluates an effect on the power grip in a horizontal transverse direction orthogonal to the horizontal preferred direction with a force above a second minimum force as a request for a change in direction of the movement and activates the direction influencing facility accordingly. Here too this type of specification is especially intuitive. This is because this is precisely how the operator would proceed if the direction influencing facility were not present or were not activated by the control facility.

Such a change in direction, initiated by the operator, within the framework of embodiments of the present invention can, at a crossing or fork for example, cause a selection to be made as the path on which the movement is to be continued. It can also cause an existing path to be left. When encountering a path, it can also cause a selection to be made as to whether to turn to the right or to the left on the path.

In an alternative embodiment, but one that is similarly intuitive for the operator, it is possible
for the control facility to evaluate a similar type of effect on a first and the second power grip of the device, which are spaced horizontally from one another seen orthogonally to a horizontal preferred direction, in the horizontal preferred direction with a first and a second force above a first minimum force as a drive request in the horizontal preferred direction and
for the control facility to evaluate a dissimilar effect on the first and the second power grip in the horizontal preferred direction, wherein the first or the second force lies above the minimum force, as a request for a change in direction of the movement and to activate the direction influencing facility accordingly.

Similar means the same indication (i.e. either two times in the preferred direction or two times opposite the preferred direction, but not once in the preferred direction and once opposite to the preferred direction) and of approximately the same size. The extent to which the amounts of the two forces can differ in order still to count as essentially the same can be defined as required.

The assessment of a dissimilar effect as a request for a change in direction of the movement can be undertaken independently of whether the current position of the device is located at least approximately on one of the paths or not. When the current position of the device is located at least approximately on one of the paths, the request can for example be used to depart from the corresponding path. In the case of branching off from a path or from a crossing the request can be used for which of the paths of the path fork or crossing is to be used. In the case of encountering one of the paths, the request can be used for which side to turn towards onto the path 1.

Expressed in simple terms: If the operator pushes or pulls on both power grips then the drive is activated according to a drive request forwards or a drive request backwards. If the operator pushes or pulls on just one of the two power grips, then in addition to a travel forwards or backwards, a change in direction is also initiated. The same can apply when the operator pushes on one of the two power grips and pulls on the other power grip.

When the device encounters a path at (initially any given) angle then, to continue the movement on the path in the one direction, there must be a change in direction by precisely this angle. To continue the movement on the same path in the opposite direction, a change in direction of 180° minus this angle is required. It is possible for the decision as to whether the movement is to be continued in the one or the other direction to always be specified by an operator. The specification can in particular be a force effect, as has already been explained above.

Preferably however the control facility, when the device encounters a path while traveling at an angle that is at a maximum as large as an acute limit angle, automatically determines in which direction it drives the device on this path. Navigation is made easier by this course of action.

This is because, when the angle is smaller than the acute limit angle, to continue the movement on the path in the one direction, a change in direction by a maximum of the acute limit angle must take place, while to continue the movement on the same path in the opposite direction, a change in direction by at least 180° minus the acute limit angle is required. For a continuation of the movement in the one direction therefore a (mostly far) smaller change in direction is required than for a continuation of the movement in the opposite direction. This can thus be evaluated by the control facility to the extent that, when it does not receive any contrary message from the operator, it decides itself the direction in which the further movement is to take place. A specification by the operator can therefore by vital in such cases.

The closer the angle at which the device encounters the path lies to 90°, the smaller are the differences between branching off in one direction or the other. In this case the decision must be made in another way, for example via a direct or indirect specification by an operator. Therefore, the limit angle must be an acute angle. The acute limit angle can—for example—lie at 60° or at 70° or at 75°.

In the event of a fork for which a request is missing for a change in direction as the further path beyond the fork, the control facility preferably automatically choses that path for which driving on the path is associated with the smallest change in direction. This means that in many cases the explicit acceptance of a request for a change in direction is then only required when the control facility has two paths available to it that are associated with the same or almost the same changes in direction to the left and right, or a path other than the path leading more or less straight on is to be followed.

The term “fork” is to be understood as being comprehensive in this context. It is intended to include both a “true” fork running more or less in a Y-shape as well as a branch (one path continues to lead straight on, one path branches off) and also a confluence (two paths branch off to the left and to the right) and also a crossing and also any other node point from which at least three paths emanate.

This characteristic can for example be exploited by the control facility to the extent that the control facility, when the speed of the movement lies above a threshold value, always drives straight on at a crossing or at a junction or selects the path with the smallest rate of change. Where necessary there can also be a multistage adaptation of the limitation of the rate of change for a change in direction of the movement depending on the speed of the movement. In this case the change in direction of the movement is limited at higher speeds to smaller values.

It is pointed out that the limitation of the change in direction of the movement does not mean that there will always and unconditionally be a change in direction of the movement. It is merely intended to mean that any change in direction is limited in any case. The rate of change of the change in direction of the movement has the dimension °/s.

Preferably the control facility causes or supports a movement on a path by taking into account limit values for temporal deviations of the position of the device on the path, wherein the limit values can vary along a respective path. Various sections of the paths can thus (by amount or vector) be assigned specific limit values for the speed, the acceleration and possibly also the sudden movement. Such limitations can in particular be sensible when the respective path makes curves and/or the device is located shortly before a crossing or fork or shortly before an end station. On straight sections of the paths on which no path forks and crossings lie a high speed can be allowed for example, while the maximum permitted speed for curves, for forks and crossings can be restricted to values that are defined according to the associated curve radii.

Preferably the control facility continuously accepts information about the environment of the device during the movement of the device, evaluates the information to the extent of whether an obstacle is located on the path, automatically plans a diversion route in the event of an obstacle by which the device can drive around the obstacle and drives the device on the diversion route. This enables the (almost) automatic operation of the mobile medical device even in the case of an unforeseen obstacle to be maintained almost without restriction. The corresponding sensors can for example be the cameras already mentioned that are installed in the building. This can also involve other sensors (camera, LIDAR, radar et.) that are arranged on the medical device and in particular, seen from the medical device, look “forwards”. Both the sensor system and also the evaluation of the signals detected by the sensor system are known as such.

In some cases, the control facility can plan the diversion route directly and also drive the device on the diversion route automatically (with the exception of the drive request). In other cases, the control facility requests the operator for a start command beforehand to drive the device on the diversion route. In yet other cases the control facility plans a number of diversion routes (in this case at most exactly two diversion routes, namely one to the left and one to the right past the obstacle) and accepts a choice of one or of the number of diversion routes from the operator directly or indirectly. The specification can be made for example by an action of the operator on a power grip similar to a specification of a change in direction. Other courses of action for choosing a diversion route are naturally also possible.

When a minimum distance to an end station is undershot with a simultaneous movement to this end station, the control facility preferably adjusts for an activation of the direction influencing facility for the purposes of moving on the path concerned. In this case the exact positioning at the end station driven to is the responsibility of the operator of the device. Thus, although the control facility continues to bring about an activation of the drive when a drive request is specified, the navigation is still the responsibility of the operator, however.

As an alternative when a minimum distance to an end station is undershot with a simultaneous movement to this end station, the control facility also drives to the end station concerned on the respective path when the drive request is no longer being specified to it. In this case it is even possible for the operator to already be away from the device and to be undertaking other tasks.

Whether and where necessary which of these two options are realized depends on the circumstances of the individual case. In particular the case in which the control facility drives automatically to an end station should only be adopted when a danger can be excluded in another way. The minimum distance can for example lie between 1 m and 5 m, in particular between 1.5 m and 3 m.

Preferably the control facility can accept a request for a reversal of direction and in this case turns the medical device around on the spot by 180° about a vertical axis. This approach can have advantages if a reversal of direction is to be undertaken on a specific path. In principle a reversal of direction can however also be undertaken when the device is not located on one of the paths.

The specification for reversal of direction can be specified to the control facility for example via an (if necessary, further) power grip or a specific button. Turning around on the spot is only possible with particular direction influencing facilities. One example of such a direction influencing facility is what is known as Mecanum kinematics.

In some embodiments it can be sensible for the control facility to accept a specification of an end station to be driven to and, building on the current position of the device and the end station to be driven to, autonomously to establish which of the paths known to it leads from the current position to the end station to be driven to. This course of action has the advantage that the control facility can decide itself at crossings and forks which path it must take. In this case the operator must merely specify the end station as such and then specify the drive request. The course of action can in particular be sensible when only a small number of end stations is possible and the device has an appropriate operator interface, so that the corresponding specification is possible.

The end stations and/or of the paths can be specified as required. For example, the corresponding information can be loaded into the control facility as a data record via a corresponding interface. Preferably the control facility accepts the end stations and/or the paths in a learning mode by a teach-in.

The term “teach-in” is generally known to persons skilled in the art of control technology. Teach-in means in general that the associated control facility is transferred into a learning mode and in the learning mode the material to be learned is specified directly by manual handling of the associated facility by an operator. In the actual case of the mobile medical device for example, for specification of an end station, the device is driven to the location concerned and then, for example by actuating a learning button, the respective location is accepted as an end station. In a similar way the control facility can be transferred into a learning mode for learning a path and the learning mode can be retained while moving along the desired path. The learning button can remain permanently actuated for this purpose.

Preferably the control facility undertakes a smoothing of the paths based on the paths specified by the teach-in. This enables the control facility to compensate for smaller inaccuracies which can easily occur within the framework of the teach-in.

Corresponding smoothing methods are generally known to persons skilled in the art. For example, the shortest smooth path can be established that deviates from the path specified directly on departure by a maximum of x centimeters and adheres to certain specifications with regard to its minimum curvature radius.

Preferably the control facility stores positions at which the device is parked, although they are not end stations, and additionally accepts such positions as end stations when the device—where necessary within a predefined period of time—is parked sufficiently often at the respective such position.

This course of action leads to the control facility also being self-learning so-to-speak during ongoing operation.

The limit for “sufficiently often” can be determined as required. It can lie at 5, 10, 15 and also at other values. The restriction to a pre-defined period of time can be given or not given. When it is given, the pre-defined period of time can lie for example at one day, one week, one month or at another suitable numerical value.

Preferably the control facility, as regards the positions at which the device is parked, although they are not end stations, also stores the associated routes to these positions and accepts these routes additionally as paths when it accepts the associated position as an additional end station. This also enables the control facility to be self-learning so-to-speak as regards the paths during ongoing operation.

A teach-in and also automatic learning are also possible for additional obstacles. When—for example—due to manual control of the device by an operator, a specific path is repeatedly left in the same area and, despite this, is driven repeatedly on around the same deviating route and then returns again to the specific path, then this can be evaluated by the control facility as a new, additional obstacle, which must be driven around in the future. In this case, although the end stations are not moved, the paths are certainly changed.

Furthermore, it may—almost naturally—be possible for the inventive mode of operation to be activated or deactivated. In the case of a deactivation, although driving support is active, i.e. the activation of the drive, the path guidance in this case is the responsibility of the operator, however. The path guidance is likewise the responsibility of the operator, when and for as long as the mobile medical device is not located on one of the paths or in its vicinity. Finally, it is always possible within the framework of unforeseen situations—even within the framework of the inventive mode of operation—for the control facility to end the movement along the respective path and only continue to activate the drive and/or the direction influencing facility as a result of corresponding specifications of the operator.

At least the object is furthermore achieved by a control program with the features as claimed. In accordance with embodiments of the present invention the processing of the machine code causes the control facility to carry out an inventive method of operation. The requirement here is for the mobile medical device additionally to have a direction influencing facility by which the direction of travel of the movement can be varied, and the direction influencing facility can be activated by the control facility.

At least the object is furthermore achieved by a control facility with the features of as claimed. In accordance with embodiments of the present invention, the control facility is programmed with an inventive computer program, so that, during operation, the control facility carries out an inventive method of operation. Here too the requirement is for the mobile medical device additionally to have a direction influencing facility, by which the direction of travel of the movement can be varied, and the direction influencing facility can be activated by the control facility.

At least the object is furthermore achieved by a mobile medical device with the features as claimed. In accordance with embodiments of the present invention, the device initially has a direction influencing facility, by which the direction of travel of the movement can be varied. Furthermore, the direction influencing facility can also additionally be activated by the control facility. Finally, the control facility is embodied as an inventive control facility.

### BRIEF DESCRIPTION OF THE DRAWINGS

The characteristics, features and advantages of this invention described above as well as the manner in which these are achieved will become clearer and easier to understand in conjunction with the description of the exemplary embodiments given below, which are explained in greater detail in conjunction with the drawings. Here, in schematic diagrams:

FIG. 1 shows a mobile medical device from the side,

FIG. 2 shows the mobile medical device from FIG. 1 from above,

FIG. 3 shows a plan of a building with paths and end stations,

FIG. 4 shows a flow diagram,

FIG. 5 shows a power grip from the side,

FIG. 6 shows a power grip from above,

FIG. 7 shows two power grips from above,

FIG. 8 shows a section of a path and a mobile medical device,

FIG. 9 shows sections of paths and a mobile medical device,

FIG. 10 shows a flow diagram,

FIG. 11 shows a path diagram,

FIG. 12 shows a path diagram,

FIG. 13 shows a flow diagram,

FIG. 14 shows a perspective diagram of a path, an obstacle and a mobile medical device,

FIG. 15 shows a flow diagram,

FIG. 16 shows a flow diagram and

FIG. 17 shows paths.

### DETAILED DESCRIPTION

It is pointed out that, independent of the grammatical term usage of a specific person-related term, individuals with male, female or other gender identities are included within the term.

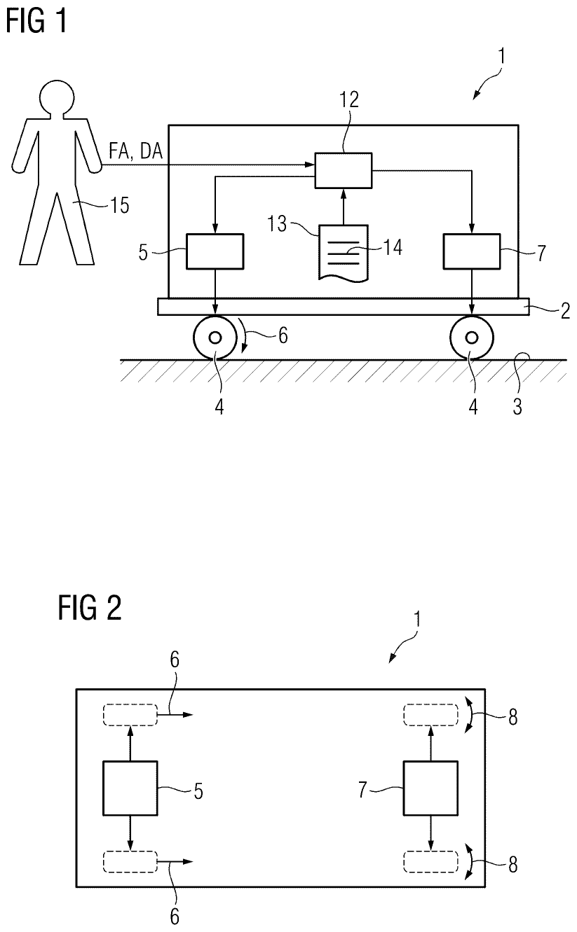

In accordance with FIGS. 1 and 2, a mobile medical device 1 has a chassis 2. Via the chassis 2 the device 1 can be driven on a floor 3. The chassis 2 comprises a number of wheels 4. The present diagram, in which a total of four wheels 4 are present, is however purely by way of example. Mostly at least three wheels 4 are present.

The device 1 furthermore has a drive 5. Via the drive 5, as indicated by arrows 6 in FIGS. 1 and 2, at least one of the wheels 4 is driven. This enables—depending on the drive force applied to the drive 5—a movement of the device 1 to be (completely) brought about or at least supported.

The device 1 furthermore has a direction influencing facility 7 (also referred to herein as a direction influencing device). Via the direction influencing facility 7, the direction of travel of the movement can be varied. For example, as indicated in FIG. 2 by arrow 8, the orientation of at least one of the wheels 4 can be influenced. Other embodiments of the direction influencing facility 7 are also possible, however. The direction influencing facility 7 is referred to for short below as the steering 7. A restriction to a steering in the narrower sense should not be associated therewith, however.

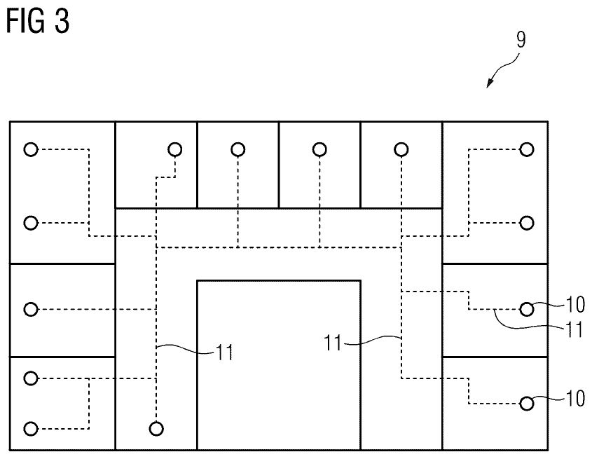

In accordance with FIG. 3 the device 1 is to be driven within a building 9. The walls of the building 9 are shown as solid lines in FIG. 3, wherein doors present in the walls or elsewhere are not shown as well. The walls are however of minor importance. What is decisive is that a number of defined end stations 10 are present. The end stations 10 are indicated in FIG. 3 by small circles. The mobile medical device 1 is to drive on defined paths 11 to the end stations 10—as a rule between the end stations 10. The paths 11 are marked in FIG. 3 by dashed lines.

Both the structure of the building 9 and also the number of end stations 10 and also the possible paths 11 are only purely by way of example. Furthermore, in FIG. 3 only a very few of the end stations 10 and also only a very few of the paths 11 are provided with their reference number.

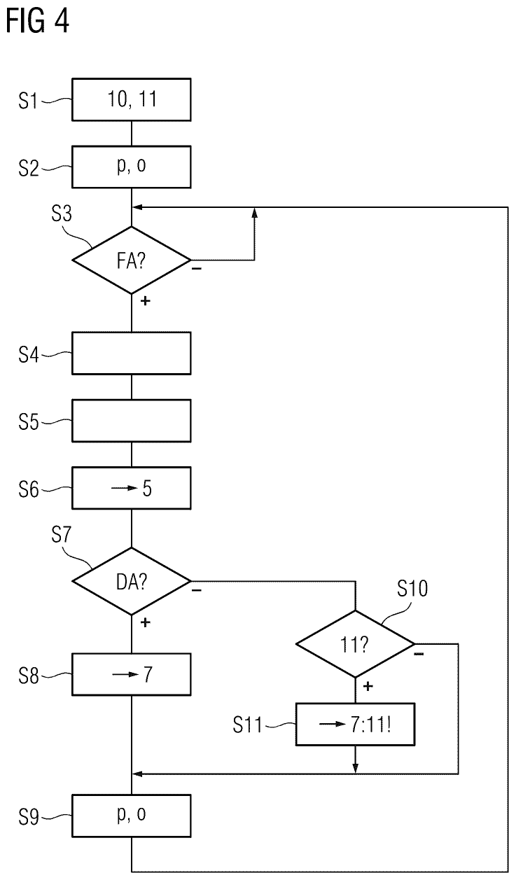

In accordance with FIG. 1 the device 1 has a control facility 12 (also referred to herein as a control device). Both the drive 5 and also the steering 7 can be activated by the control facility 12. The control facility 12 is programmed with a control program 13. The control program 13 comprises machine code 14 that is able to be processed by the control facility 12. The processing of the machine code 14 by the control facility 12 causes the control facility 12 to carry out a method of operation of which the basic principle is subsequently explained in greater detail in conjunction with FIG. 4. Embodiments of this basic principle will be explained later in conjunction with the further FIG.

In accordance with FIG. 4, in a step S1, the end stations 10 and the paths 11 are made known to the control facility 12. The step S1 can principally be implemented in any given manner. A preferred type of implementation of step S1 will be explained in greater detail later.

In a step S2 a current position p of the device 1 is made known to the control facility 12. Often the control facility 12, in step S2, is additionally also made aware of the orientation o of the device 1. For example, there can be an explicit specification by an operator 15. Other possibilities are also provided.

In a step S3 the control facility 12 checks whether a drive request FA is being specified to it by the operator 15 (see FIG. 1). If this is the case, the control facility 12 accepts the drive request FA in a step S4. Otherwise, the control facility 12 returns directly to step S3.

It is always only briefly expressed below that the drive request FA is specified to the control facility 12. The issues will thus be described as seen by the operator 15. As seen by the control facility 12 this always corresponds to the issues in which the control facility 12 accepts the drive request FA. Similar issues apply for other requests, which are specified to the control facility 12 by the operator 15 and accordingly also accepted by the control facility 12.

In the case of a drive request FA the control facility 12 establishes in a step S5, while assessing the drive request FA, an at least rough desired direction of the movement. In some cases—namely when the driven wheels 4 can only be driven by the drive 5 in the “forward” direction—the execution of step S5 can be trivial. In other cases, for example a distinction can be made between the forward and backward directions. In a step S6 the control facility 12 activates the drive 5 according to the desired direction established in step S5.

In a step S7, the control facility 12 checks whether, in addition to the drive request FA, a request DA for a change in direction (called turn request DA for short below) has been specified to it by the operator 15. If this is the case the control facility 12, in a step S8, controls the steering 7 accordingly. The control facility 12 then moves to a step S9. In step S9 the control facility 12 updates the current position p (and where necessary also the current orientation o) of the device 1. From step S9 the control facility 12 goes back again to step S3.

When the control facility 12 does not move from step S7 to step S8, the control facility 12 moves to a step S10. In step S10 the control facility 12 checks whether the current position p of the device 1 is located at least approximately on one of the paths 11. When this is the case the control facility moves to a step S11. In step S11 the control facility 12 activates the steering 7 in addition to drive 5. The activation is undertaken in such a way that the device 1 is driven on the path 11 concerned on which it is located at that moment. From step S11 the control facility 12 moves to step S9.

When the control facility 12 does not move from step S10 to step S11, the control facility 12 moves directly to step S9. Step S10 is thus skipped.

From the course of action of FIG. 4 various issues are evident. These basic principles also apply for the embodiments still to be explained later.

It can first be seen that the control facility only carries out the steps S4 and the steps S5 to S11 when the drive request FA has been specified to it. A cycle time, during which the control facility 12 carries out the step S3, and where necessary also the steps S4 to S11 following on from it once in each case, mostly lies in the region of a few milliseconds. Thus, the drive 5 and where necessary also the steering 7 are only activated for as long as the control facility 12 is accepting the drive request FA.

It can furthermore be seen that a drive request FA and also a turn request DA are always carried out. The course of action of FIG. 4 is thus also able to be carried out when the device 1 is not located on one of the paths 11. It is only step S11 that is not carried out in this case.

It can furthermore be seen that the specification of a change in direction by the operator 15 has priority over remaining on one of the paths 11. Provided the device 1 is located on one of the paths 11 however, the movement of the device 1 follows the corresponding path 11. This not only applies when the corresponding path 11 runs straight on, but also when the corresponding path 11 has curves or kinks.

Finally, it can be seen that the control facility 12 continuously updates the current position p (and where necessary also the current orientation o) of the device 1 during the movement.

Where necessary, the drive 5 and/or the steering 7 can also be switched off by the operator 15. In this case there is no activation of the drive 5 and/or of the steering 7 by the control facility 12. As a rule, however the updating of the position p and where necessary also of the orientation o also continues to be carried out in this case. Furthermore, it is also possible to switch off the inventive method as such and to operate the device 1 in the conventional manner. In this case the steps S10 and S11 are not executed. In the NO branch of step S7 in this case the method moves directly to step S9.

FIGS. 5 and 6 show a possible preferred manner in which a drive request FA can be specified to the control facility 12. In accordance with FIGS. 5 and 6 the device 1 has a (first) power grip 16. The power grip 16 can for example, as is indicated in FIGS. 5 and 6 by arrows 17 and 18, be moved slightly (very small distances of a few millimeters and possibly even less are sufficient) forwards and possibly also backwards. Also, a pure exertion of a force, i.e. without mechanical movement, can suffice. A movement forwards and also a possible movement backwards only occur when the operator 15 acts with a corresponding force F1 or F2 in a horizontal direction—referred to below as the horizontal preferred direction—on the power grip 16. Furthermore, the respective force F1, F2 must be above a first minimum force Fmin1, which opposes a deflection from a rest position against the power grip 16. If the force F1>Fmin1 acts on the power grip 16—with or without mechanical movement—in the preferred direction, then the control facility 12 evaluates this as a drive request FA in the horizontal preferred direction (“forwards”). If the force F2>Fmin1 acts on the power grip 16—with or without mechanical movement—against the preferred direction, then the control facility 12 evaluates this as a drive request FA opposite to the horizontal preferred direction (“backward”). Corresponding sensor systems are generally known to persons skilled in the art and therefore do not have to be explained in detail here.

In many cases it is furthermore possible, in accordance with the diagram in particular in FIG. 6, also to act on the power grip 16 in a horizontal transverse direction orthogonal to the horizontal preferred direction. Similarly to the course of action when specifying a drive request FA, for example, as is indicated in FIGS. 5 and 6 by arrows 19 and 20, there can be slight movement (as before very small distances of just a few millimeters and possibly even less can suffice) to the left and to the right. Movement to the left or right only occurs when the operator 15 acts with a corresponding force F3 or F4 in the transverse direction on the power grip 16. Furthermore, the respective force F3, F4 must be above a second minimum force Fmin2, which sets deflection from a rest position against the power grip 16. If the force F3>Fmin2 acts on the power grip 16 in the transverse direction to the left, then the control facility 12 evaluates this as a turn request DA to the right or left (note the order of the two terms). If the force F4>Fmin2 acts on the power grip 16 in the transverse direction, then the control facility 12 evaluates this as a turn request DA to the left or right (note the order of the two terms). Corresponding sensor systems are generally also known here to persons skilled in the art and therefore do not have to be explained in detail. Furthermore, embodiments are also possible here that are able to be realized without mechanical movements, i.e. with pure recognition of the force as such.

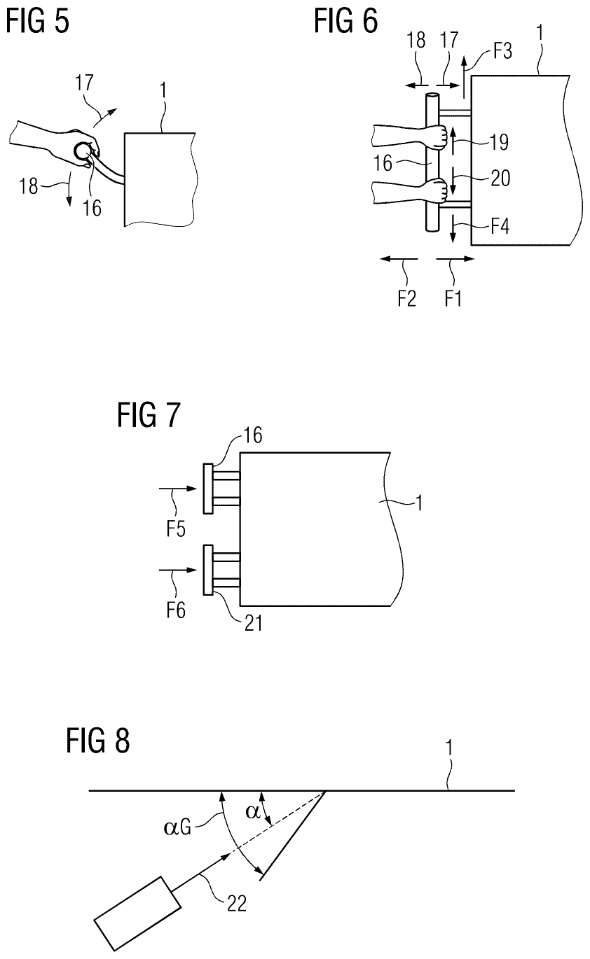

FIG. 7 shows a possible and likewise preferred alternative manner to that of FIGS. 5 and 6 in which a drive request FA and a turn request DA can be specified to the control facility 12. In accordance with FIG. 7, the device 1, in addition to the first power grip 16, has a second power grip 21. The two power grips 16, 21, viewed in the transverse direction, are spaced apart from one another. Forces F5 and F6 can be exerted in each case on the two power grips 16, 21 in each case. With a respective positive value the respective force F5, F6 is directed in the horizontal preferred direction (“forward”), with a respective negative value against the horizontal preferred direction (“backward”). The forces F5 and F6 exerted on the two power grips 16, 21 can be evaluated by the control facility 12 (for example) as follows:

If the amounts of the two forces F5, F6 lie below the minimum force Fmin1, the control facility 12 evaluates this to the extent that neither a drive request FA nor a turn request DA is being specified.

If the amounts of the two forces F5, F6 are above the minimum force Fmin1, the control facility 12 evaluates this as follows:

If both forces F5, F6 are greater than 0, then a drive request FA to drive forward is present.
If both forces F5, F6 are less than 0, then a drive request FA to drive backward is present.
If the force F5 is greater than 0 and the force F6 is less than 0, then a turn request DA in the one direction is present.
If the force F5 is less than 0 and the force F6 is greater than 0, then a turn request DA in the other direction is present.

If the amount of one of the two forces F5, F6 lies above the minimum force Fmin1 and the other lies below it, then the control facility 12 evaluates this as follows:
If the amount of the force F5 is greater than the minimum force Fmin1, then, depending on the leading sign of the force F5, a turn request DA in the one or the other direction is present.
If the amount of the force F6 is greater than the minimum force Fmin1, then, depending on the leading sign of the force F6, a turn request DA in the other or in the one direction is present.

As a result, the control facility 12 evaluates an effect of a similar type on the two power grips 16, 21 in the horizontal preferred direction with a first and a second force F5, F6 of above the first minimum force Fmin1 as a drive request in the horizontal preferred direction. Likewise, the control facility 12 evaluates an effect of a dissimilar type on the two power grips 16, 21 in the horizontal preferred direction as a turn request DA, provided (at least) one of the two forces F5, F6 lies above the first minimum force Fmin1.

As already mentioned, it is not absolutely necessary for the device 1 to be driven on one of the paths 11. If the device 1 is not driven on one of the paths 11, the case can occur in which, while the device 1 is being driven, the device 1, according to the diagram in FIG. 8, while being driven (indicated in FIG. 8 by an arrow 22) encounters one of the paths 11. In this case the further movement of the device 1 is preferably continued on the path 11. It is possible for the operator 15 always to decide whether, according to the diagram in FIG. 8, the device is to be turned to the right or to the left. Preferably however the control facility 12 establishes an angle α by which the device 1 encounters the path 11. Both the establishment of encountering a path 11 as such and also the establishment of the angle α are readily possible since the paths 11 are known to the control facility 12 in any event and due to the order of the current positions p the direction of movement of the device 1 can also be known.

The control facility 12 can compare the established angle α with a limit angle αG. The limit angle αG is an acute angle. It is thus less than 90°. If the angle α is at a maximum as large as the limit angle αG, then the control facility 12, on encountering the path 11, can automatically define the direction in which it moves the device 1 on this path 11. The direction is—naturally—selected such that, when compared to the direction of movement at that moment, as indicated by the arrow 22, it is linked to the smallest change in direction. The limit angle αG can lie at 70° for example.

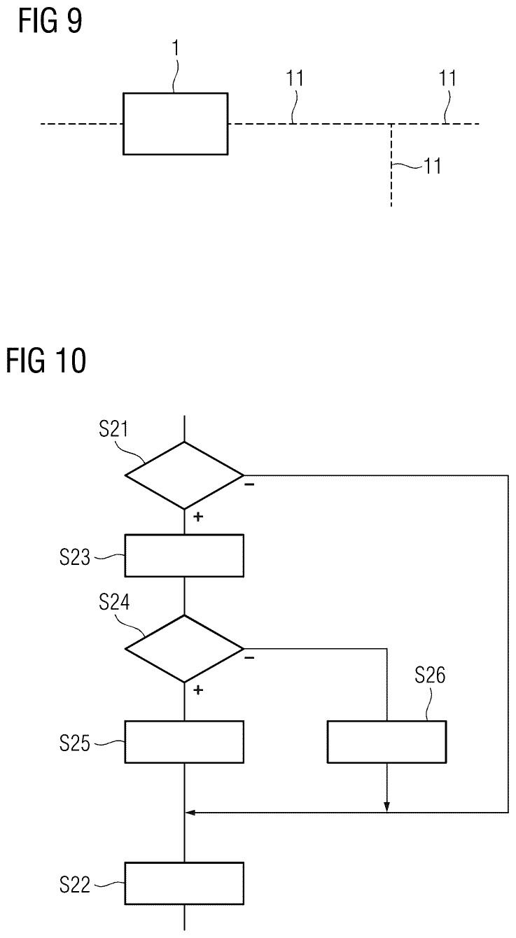

As can already be seen from FIG. 3 and is shown more clearly in FIG. 9, the paths 11 can join, cross, fork etc. as required. The control facility 12 as a rule does not know the end station 10 to which the device is to drive. When the device 1 is driven on a path 11, the control facility 12 may therefore not know, in the event of a crossing or fork in some cases, the path 11 upon which the device 1 should be driven further after the crossing or fork. It is always possible for the operator 15 to make a corresponding specification to the control facility 12. This course of action can be supplemented by taking into account the speed of movement of the device 1: If the speed of movement lies above a limit value, then after the crossing or fork that path 11 that is linked to the smallest change in direction always continues to be taken. If, however, the speed of movement lies below the limit value, the operator 15 is asked before the crossing or fork always which further path 11 is to be taken after the crossing or fork.

In the case in which the speed of movement lies below the limit value, the operator 15 may furthermore decide not to specify any turn request DA. In this case, that further path 11 beyond the crossing is taken that is linked to the smallest change in direction.

A wish to branch off can be specified to the control facility 12 by a corresponding turn request DA. It may be sufficient here for the turn request DA only to be specified briefly, i.e. in particular not during the entire period of time of—for example—5 s, that is needed for a complete change from the direction of travel before the fork into the new direction of travel after the crossing or fork. If for example the distance to the crossing or fork is less than x meters or taking into account the speed at the time) is less than y seconds and the operator 15 of the control facility 12 briefly (for example for more than 0.2 s, but less than 1 s) specifies a turn request DA to the right, then the control facility 12, due to the turn request DA, can “know” that a right turn is to be taken at the crossing or fork.

This course of action is explained below in greater detail in conjunction with FIG. 10. Within the framework of the course of action of FIG. 10 the requirement is that the device 1 is already being driven on one of the paths 11. FIG. 10 thus shows a possible embodiment of step S11.

In accordance with FIG. 10 the control facility 12, in a step S21, checks whether the device 1 is approaching a fork or crossing on the path 11 along which it is currently being driven. If this is not the case, the control facility 12, in a step S22, follows the path 11 currently being driven.

If the device 1 is approaching a fork or crossing, then the control facility 12, in a step S23, selects that path 11 beyond the fork or crossing that forms the smallest angle with the path 11 currently being driven, thus the path on which a continuation of the path 11 currently being driven with the smallest change in direction is produced. Where necessary the step S23 can be modified to the extent that the control facility 12, in step S23, only selects one path 11 when this path is a straight continuation of the path 11 currently being driven or is only linked to a change in direction that does not exceed a predetermined limit value.

The control facility 12 then checks, in a step S24, whether the current speed lies above a minimum speed. If this is the case then the control facility 12, in a step S25, selects the path 11 selected in step S23 as that path 11 on which the movement of the device 1 is to be continued. Otherwise, it is necessary for the operator 15 of the control facility 12, in a step S26, to specify a choice of one of the paths 11. The specification, as already mentioned, can be a specification for a brief time, thus does not have to be in force during the entire change in direction. Where necessary it can also involve a confirmation that the device is to be driven (more or less) straight on.

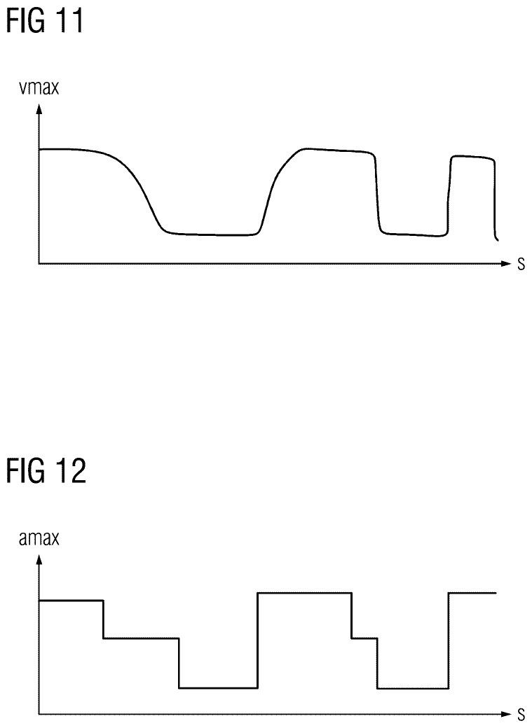

In the simplest case only the paths 11 as such are known to the control facility 12. It is possible however, together with the paths 11, also for limit values vmax, amax for temporal derivations of the position of the device 1 on the paths 11 to be known to the control facility 12. FIG. 11 shows, purely by way of example, a possible course of a limitation of the speed of movement along one of the paths 11. FIG. 12 shows, in a similar way by way of example, a possible course of a limitation of the acceleration along this path 11. The reference character s designates the (scalar) location along the respective path 11. The specification of the limit values vmax, amax naturally does not mean that the device 1 is driven with these limit values vmax, amax. The limit values vmax, amax represent upper limits however that are adhered to when the device 1 is being driven. The limit values vmax, amax are usually amounts. They apply as a rule to both directions of travel and to both directions of action. Where necessary however they can also be specified as a function of the direction of travel and/or as a function of the direction of action.

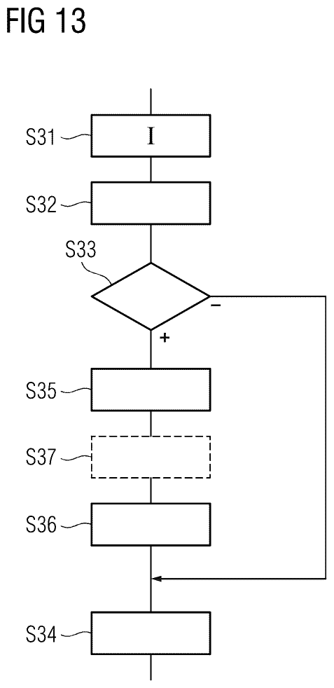

In a further preferred embodiment of the present invention the control facility 12 continuously accepts information I about the environment of the device 1 while the device 1 is being driven. For example—see FIG. 1—a camera 23 looking in the direction of travel or the like can be arranged on the device 1, the captured images of which are fed to the control facility 12. In the case of the continuous acceptance of information I, the step S11 or the step S22 can be designed in such a way as that explained below in conjunction with FIG. 13.

In accordance with FIG. 13 the control facility 12, in a step S31, accepts the information I. In a step S32 the control facility 12 prepares the accepted information I. Corresponding algorithms are generally known to persons skilled in the art.

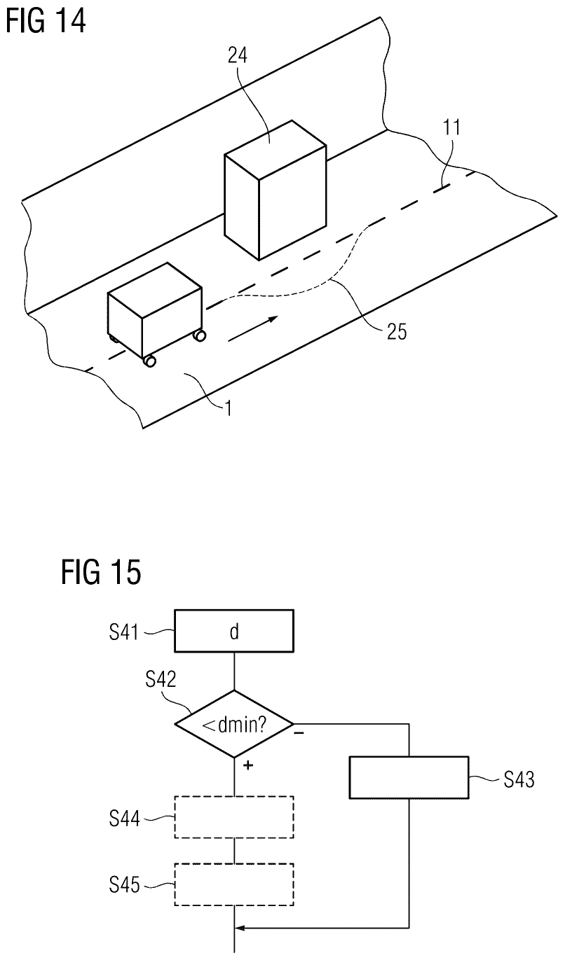

In a step S33 the control facility 12 checks whether, with the aid of the accepted information I, it recognizes an obstacle 24—see FIG. 14—on the path 11 currently being driven. The control facility 12, within the framework of step S33, as well as the established position and the established dimensions of the obstacle 24, also takes account of the dimensions of the mobile medical device 1 known to it. When and for as long as no obstacle 24 is recognized, the control facility 12, in a step S34, follows the path 11 currently being driven.

If however, the control facility 12 recognizes an obstacle 24, then the control facility 12, in a step S35, automatically plans (at least) one diversion route 25 by which the device can drive around the obstacle 24 and then the further movement of the device 1 on the path 11 can be continued. In a step S36 the control facility 12 then accepts the newly planned diversion route 25 (or one of the planned diversion routes 25) for the corresponding section of the path 11 as a new path 11. Only then does the control facility 12 move to step S34. In the current execution of step S34 the path 11 is continued while taking into account the diversion route 25. The control facility 12 thus moves the device 1 on the diversion route 25.

Where necessary a step S37 can be present in addition, in which the control facility 12 accepts from the operator 15 a choice of a number of planned diversion routes 25 or a confirmation of the (single) planned diversion route 25. In some cases, or situations step S37 can be omitted or skipped, however. Step S37 is only shown by a dashed outline in FIG. 13 because it does not always necessarily have to be present and/or carried out.

FIG. 15 shows a further possible embodiment of step S11 or of step S22 or of step S34. The course of action of FIG. 15 is as a rule only relevant when the device 1 is located on one of the paths 11 and, seen in direction of travel, the path 11 has no crossings or forks before the end station 10. In these situations, only this one end station 10 can be driven to. It is important in this context that the device 1 is driven towards this end station 10, i.e. not away from the end station 10.

In accordance with FIG. 15 the control facility 12 in this case, when driving along the path 11, in a step S41 can continuously establish the remaining distance d between the device 1 and the respective end station 10. The distance d does not necessarily correspond to the geometric distance, but as a rule corresponds to the distance still to be driven along the path 11. In a step S42 the control facility 12 can check whether the distance d is below a minimum distance dmin. Provided the distance is more than the minimum distance dmin, in a step S43 “normal” driving along the path 11 takes place, i.e. driving on the one hand under the control of the operator 15, but on the other hand while keeping to the path 11. On the other hand, if the minimum distance dmin is exceeded, then the control facility 12 can move to a step S44 or a step S45. Only one of the two steps S44 and S45 is ever carried out. Which of the two steps is carried out can vary from end station 10 to end station 10.

In step S44 the control facility 12—where necessary after previously being enabled to do so by the operator 15—takes over the control of driving the device 1 to the end station 10 completely. This course of action can be sensible if on the one hand an exact positioning at the end station 10 is required and on the other hand unforeseen events during the remaining journey of the device 1 can be excluded. An example of such a situation can be the docking of a patient couch at a medical imaging modality, for example a CT system or an MR system. While step S44 is being carried out it can be immaterial whether the drive request FA is still being specified to the control facility 12 or is no longer being specified to it.

In step S45 the control facility 12 adjusts an activation of the steering 7 for the purposes of driving on the path 11 concerned. Steering movements are thus only made as a result of a corresponding specification by the operator 15. This course of action can in particular be sensible if only the operator 12 has the necessary knowledge about which exact position p (and where necessary with what exact positioning o) the device 1 is to be parked at the end station 10.

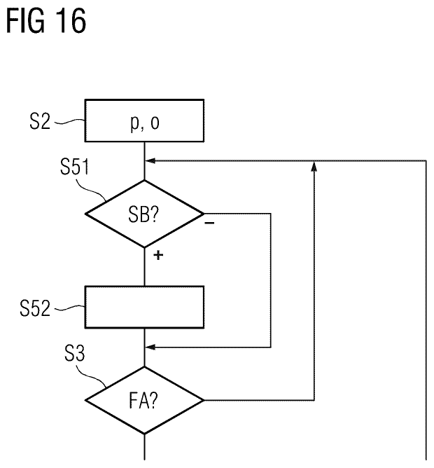

FIG. 16 shows an optional embodiment of the course of action from FIG. 4. FIG. 16 only shows the relevant parts of FIG. 4 here. The remaining parts of FIG. 4 are retained unchanged.

In accordance with FIG. 16 steps S51 and S52 are inserted between steps S2 and S3. In step S51 the control facility 12 checks whether a special command SB to turn has been specified to it by the operator 15. If the special command SB is not specified to it, the control facility 12 skips step S52 and thus goes directly to step S3. If, by contrast, special command SB is specified to it, then the control facility 12, in step S52, activates the steering 7 in such a way that the medical device 1 turns on the spot by 180° about a vertical axis. This is so to speak an “about turn”. The carrying out of step S52 is in particular of advantage when the device 1 is already located on one of the paths 11. In principle the execution is also possible when this is not the case. Of importance furthermore is that the steps S51 and S52 are bound into the loop which, within the framework of FIG. 4, begins with step S3. From step S3 onwards and also from step S9 onwards (cf. FIG. 4) the control facility 12, in the case of the embodiment in accordance with FIG. 16, thus does not go back to step S3, but to step S51.

As a general rule the end stations 10 and the paths 11 as such are known in advance to the control facility 12. By contrast it is not known in advance to the control facility 12 as a general rule which actual end station 10 is to be driven to. An exception is the situation already explained in which, seen in the direction of travel from the current position p of the device 1, there are no crossings and forks, but only a single end station 10.

A further exception can be produced by the operator 15 being given the opportunity to select a specific end station 10 as the end station 10 to be driven to and specifying it to the control facility 12. In this case the control facility 12, building on the current position p of the device 1 and the end station 10 to be driven to, can automatically establish which of the paths 1 known to it leads from the current position p to the end station 10 to be driven to. The specification of an end station 10 to be driven to can in particular be sensible when the device 1 is already located on one of the paths 11. In principle the specification of an end station 10 to be driven to is also possible however when the device 1 is not yet located on one of the paths 11. In this case the control facility 12 can for example, starting from the current position p, where necessary additionally taking into account the current orientation o, determine the next location lying on one of the paths 11 and plan starting from this location.

Various options are provided for the specification of the end stations 10 and of the paths 11. For example, the corresponding information can be loaded into the control facility 12 in the manner of a program or other dataset. Preferably the control facility 12 accepts the end stations 10 and/or the paths 11 in a learning mode by a teach-in however.

To carry out the teach-in the control facility 12 is first placed in the learning mode by the operator 15, for example by actuation of a specific button (learn button) or by specifying a numerical code. The device 1 is then operated in a similar mode of operation to that described above in conjunction with FIG. 4. One difference lies in the fact that in this learning mode the steps S10 and S11 are always skipped. The steps S10 and S11 are thus never carried out in the learning mode. A further difference lies in the fact that the control facility, 12 during the driving of the device 1, continuously stores the positions p and where necessary also orientations o of the device 1 and in this way creates a path 11. An end station 10 can be “learnt” in the learning mode for example by the operator 15 driving the device 1 to a specific position p and then actuating a special button. As a result of the actuation of the special button the control facility 12 can in this case take over the position p given at this point in time as the end station 10. With the ending of the learning mode the end stations 10 and the paths 11 are thus determined.

For a new transition into the learning mode two different courses of action are possible. On the one hand the end stations 10 and paths 11 learnt in the previous learning mode can be erased, so that the learning can begin again from the start. On the other hand the end stations 10 and paths 11 learnt in the previous learning mode can be retained, so that learning starts from the state of knowledge at that moment as seen by the control facility 12.

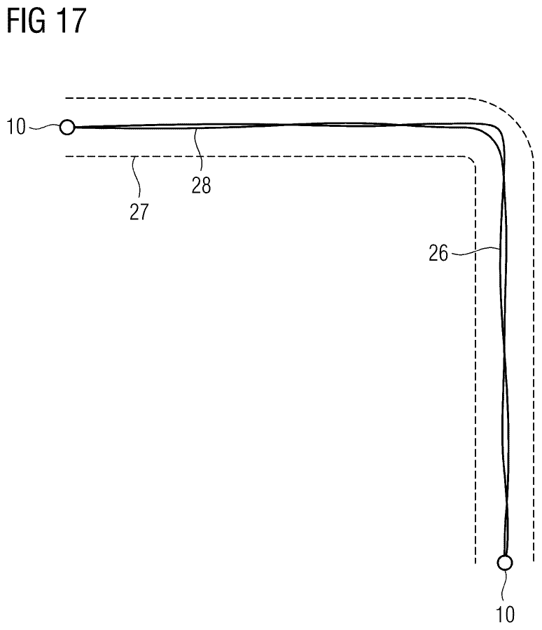

It is possible for the control facility 12 to accept the paths 11 exactly as specified to it by the operator 15 within the framework of the teach-in. The path specified within the framework of the teach-in—provided with the reference number 26 in FIG. 17—will however never run straight over longer routes. The cause is simply that the operator 15, when driving the device 1, mostly does not take exactly the right direction, but always has to make small directional corrections. FIG. 17 shows this purely by way of example for the case in which two essentially straight sections are followed from one end station 10 to another end station 10, which adjoin one another at an appreciable angle (in the example shown of around 90°). If in normal operation the path 26 specified within the teach-in were now followed exactly, then the small directional corrections would also be followed. This is not necessary however. Preferably the control facility 12 therefore, building on the path 26 specified by the teach-in, undertakes a smoothing of this path 26. For example, the control facility 12 can for this purpose first define a tubular outline 27 around the path 26 specified within the framework of the teach-in. Within this tubular outline 27 the control facility 12, as the resulting path 28 (as a result the path 11), can define a path that is as straight as possible and at those points at which a change in direction is unavoidable, adheres to specific conditions, for example does not go below a minimal curvature radius.

In addition to the dedicated learning mode, as has been explained above, an implicit learning mode similar to a teach-in is also possible during ongoing operation (FIG. 4). In this case the control facility 12, during the ongoing operation, in addition to the course of action of a teach-in, realizes that the positions p that are not end stations 10 and at which the device 1 is parked by the operator 15, are stored and also the associated route (this choice of word is chosen to make a distinction from a path 11) is stored. The respective position p is thus not (yet) an end station 10 and the associated route, where it lies outside the paths 11, is not (yet) a path 11.

A one-time use of such a position p for parking the device 1 is not yet a sufficient indication of a “new end station”. The control facility 12 can however accept such a position p and the associated route (the latter where necessary after a preparation corresponding to the course of action of FIG. 17) as a new end station 10 and associated path 11 when the device 1—where necessary within a predefined period of time—is parked sufficiently often at the corresponding position p. For example, an acceptance as a new end station 10 and associated path 11 can occur when the corresponding position p (independently of a period of time) is driven to a total of at least ten times or is driven to at least three times during a day or is driven to at least five times during a week. Where necessary an acceptance can also only occur when it is previously confirmed by the operator 15.

In summary, embodiments of the present invention thus relate to the following subject matter:

A mobile medical device 1 is able to be driven via a chassis 2 on a floor 3 within a building 9. The movement of the device 1 can be brought about or at least supported by at least one drive 5. Via a direction influencing facility 7 the direction of travel of the movement can be varied. Both the drive 5 and also the direction influencing facility 7 can be activated by a control facility 12. End stations 10 and paths 11 leading to the end stations 10 as well as a current position p of the device 1 are known to the control facility 12. The control facility 12 accepts a drive request FA from an operator 15 and, by evaluating the drive request FA, establishes an at least approximate desired direction of the movement. The control facility 12 only activates the drive 5 for as long as it is accepting the drive request FA. The control facility 12, in addition to the drive 5, activates the direction influencing facility 7 so that the device 1 is driven on one of the paths 11 when it accepts the drive request FA and the current position p of the device 1 is located at least approximately on this path 11. The control facility 12, during the movement, furthermore, continuously updates the current position p of the device 1.

One or more embodiments of the present invention have many advantages. In particular the previous interaction of the operator 15 with the device 1 can be retained unchanged. Essentially the operator 15 pushes or pulls the device 1 as before and steers it when needed. Despite this the paths 11 are kept to, which is of significant advantage in particular when negotiating curves and with an inexperienced operator 15. The control of the movement as such still remains with the operator 15. Particular safety-relevant aspects therefore do not have to be noted. Significant advantages are nevertheless produced in the medical workflow. Any states—for example activation of the guidance on one of the paths 11 when encountering a path 11, basic activation of the inventive method of operation and more besides can be indicated optically, acoustically, haptically etc.

It will be understood that, although the terms first, second, etc. may be used herein to describe various elements, components, regions, layers, and/or sections, these elements, components, regions, layers, and/or sections, should not be limited by these terms. These terms are only used to distinguish one element from another. For example, a first element could be termed a second element, and, similarly, a second element could be termed a first element, without departing from the scope of example embodiments. As used herein, the term “and/or,” includes any and all combinations of one or more of the associated listed items. The phrase “at least one of” has the same meaning as “and/or”.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

Spatial and functional relationships between elements (for example, between modules) are described using various terms, including “on,” “connected,” “engaged,” “interfaced,” and “coupled.” Unless explicitly described as being “direct,” when a relationship between first and second elements is described in the disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” on, connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Also, the term “example” is intended to refer to an example or illustration.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

It is noted that some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed above. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments. The present invention may, however, be embodied in many alternate forms and should not be construed as limited to only the embodiments set forth herein.

In addition, or alternative, to that discussed above, units and/or devices according to one or more example embodiments may be implemented using hardware, software, and/or a combination thereof. For example, hardware devices may be implemented using processing circuity such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner. Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

Even further, any of the disclosed methods may be embodied in the form of a program or software. The program or software may be stored on a non-transitory computer readable medium and is adapted to perform any one of the aforementioned methods when run on a computer device (a device including a processor). Thus, the non-transitory, tangible computer readable medium, is adapted to store information and is adapted to interact with a data processing facility or computer device to execute the program of any of the above mentioned embodiments and/or to perform the method of any of the above mentioned embodiments.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as a computer processing device or processor; however, one skilled in the art will appreciate that a hardware device may include multiple processing elements or processors and multiple types of processing elements or processors. For example, a hardware device may include multiple processors or a processor and a controller. In addition, other processing configurations are possible, such as parallel processors.

The computer programs include processor-executable instructions that are stored on at least one non-transitory computer-readable medium (memory). The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc. As such, the one or more processors may be configured to execute the processor executable instructions.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

Further, at least one example embodiment relates to the non-transitory computer-readable storage medium including electronically readable control information (processor executable instructions) stored thereon, configured in such that when the storage medium is used in a controller of a device, at least one embodiment of the method may be carried out.

The computer readable medium or storage medium may be a built-in medium installed inside a computer device main body or a removable medium arranged so that it can be separated from the computer device main body. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Although the present invention has been illustrated and described in greater detail by embodiments thereof, the present invention is not restricted by the disclosed examples and other variations can be derived herefrom by the person skilled in the art without departing from the scope of protection of the present invention.

What is claimed is:

1. A method of operation of a mobile medical device, the mobile medical device including a chassis by which the mobile medical device is driven on a floor within a building, at least one drive configured to move, or support movement of, the mobile medical device, a direction influencing device configured to vary a direction of travel of the mobile medical device, and a control device configured to activate the at least one drive and the direction influencing device, wherein a number of end stations and a number of paths leading to the end stations are known to the control device, wherein a current position of the mobile medical device is known to the control device, and wherein the method comprises:
accepting, by the control device, a drive request from an operator;
establishing, by the control device, at least an approximate desired direction of movement by evaluating the drive request;
activating, by the control device, the at least one drive only while the control device is accepting the drive request;
activating, by the control device, the direction influencing device to drive the mobile medical device on a path among the paths while the control device is accepting the drive request and while the current position of the mobile medical device is located at least approximately on the path; and
continuously updating, by the control device, the current position of the mobile medical device during movement of the mobile medical device.

2. The method of operation as claimed in claim 1, wherein the control device evaluates an effect, on a first power grip of the mobile medical device in a horizontal direction, of the drive request in the horizontal direction and having a force above a first minimum force.

3. The method of operation as claimed in claim 2, wherein the control device evaluates an effect, on the first power grip in a horizontal transverse direction, of a request for a change in direction of the movement with a force above a second minimum force, wherein the control device activates the direction influencing device accordingly, and wherein the horizontal transverse direction is orthogonal to the horizontal direction.

4. The method of operation as claimed in claim 1, wherein
the control device evaluates an effect, in a horizontal direction and on a first power grip and a second power grip of the mobile medical device, of a drive request in the horizontal direction and with a first force and a second force above a first minimum force, wherein the first power grip and the second power grip are spaced horizontally from one another when viewed orthogonally to the horizontal direction, and
the control device evaluates an effect on the first power grip and the second power grip in the horizontal direction, of a request for a change in direction of the movement with the first force or the second force above the first minimum force, and the control device activates the direction influencing device accordingly.

5. The method of operation as claimed in claim 1, wherein, when the mobile medical device encounters a path while driving at an angle that is less than or equal to an acute limit angle, the control device automatically determines the direction in which to drive the mobile medical device on the path.

6. The method of operation as claimed in claim 1, wherein, in case of a fork and in absence of a request for a change in direction as a further path beyond the fork, the control device automatically selects a path for which driving on said path corresponds to a minimum change in direction.

7. The method of operation as claimed in claim 1, wherein the control device brings about, or at least supports, movement on the path, taking into account limit values for temporal derivations of the current position of the mobile medical device on the path, wherein the limit values vary along the path.

8. The method of operation as claimed in claim 1, wherein
while the mobile medical device is being driven, the control device continuously accepts information about an environment of the mobile medical device,
the control device evaluates the information about the environment to determine whether an obstacle is located on the path, and
in the event of an obstacle on the path, the control device automatically plans a diversion route by which the mobile medical device drives around the obstacle and on the diversion route.

9. The method of operation as claimed in claim 1, wherein, when a minimum distance to an end station is not reached, with a simultaneous movement towards the end station, the control device either sets an activation of the direction influencing device to drive on the path or drives towards the end station on the path when the control device is no longer accepting the drive request.

10. The method of operation as claimed in claim 1, wherein the control device is configured to accept a request for reversal of direction, and turn the mobile medical device by 180° about a vertical axis based on the request for reversal of direction.

11. The method of operation as claimed in claim 1, wherein
the control device accepts a specification of an end station to be driven to, and
building on the current position of the mobile medical device and the end station to be driven to, automatically establishes which path leads from the current position to the end station.

12. The method of operation as claimed in claim 1, wherein the control device accepts at least one of the end stations or the paths in a learning mode by a teach-in.

13. The method of operation as claimed in claim 12, wherein the control device, building on the paths specified by the teach-in, undertakes a smoothing of the paths.

14. The method of operation as claimed in claim 1, wherein the control device accepts positions at which the mobile medical device is parked, but that are not end stations, stores the positions, and accepts a position as an end station when the mobile medical device is parked at the position a threshold number of times.

15. The method of operation as claimed in claim 14, wherein, with regard to the positions at which the mobile medical device is parked, the control device also stores associated routes to the positions and accepts the associated routes as paths when the positions are accepted as end stations.

16. A non-transitory computer-readable storage medium storing a control program for a control device of a mobile medical device that includes a chassis by which the mobile medical device is driven on a floor within a building, at least one drive to move, or support movement of, the mobile medical device, and a direction influencing device configured to vary the direction of travel of the mobile medical device, wherein the control program comprises machine code that, when processed by the control device, causes the control device to carry out the method as claimed in claim 1.

17. A control device of a mobile medical device including a chassis by which the mobile medical device is driven on a floor within a building, at least one drive configured to move, or support movement of, the mobile medical device, and a direction influencing device configured to vary the direction of travel of the mobile medical device, wherein the control device is configured to carry out the method as claimed in claim 1.

18. A mobile medical device, comprising:
a chassis by which the mobile medical device is driven on a floor within a building;
at least one drive configured to move, or support movement of, the mobile medical device;
a direction influencing device configured to vary the direction of travel of the mobile medical device; and
the control device of claim 17, wherein the control device is configured to activate the at least one drive and the direction influencing device.

19. The method of operation as claimed in claim 7, wherein, when a minimum distance to an end station is not reached, with a simultaneous movement towards the end station, the control device either sets an activation of the direction influencing device to drive on the path or drives towards the end station on the path when the control device is no longer accepting the drive request.

20. The method of operation as claimed in claim 9, wherein the control device accepts positions at which the mobile medical device is parked, but that are not end stations, stores the positions, and accepts a position as an end station when the mobile medical device is parked at the position a threshold number of times.
